(19) United States
(12) Patent Application Publication
(10) Pub. No.: US 2024/0310757 A1
(43) Pub. Date: Sep. 19, 2024

(54) IMAGE FORMATION APPARATUS AND METHOD FOR MANUFACTURING IMAGE FORMATION APPARATUS

(71) Applicant: Oki Electric Industry Co., Ltd., Tokyo (JP)

(72) Inventor: Yasumasa SAGAWA, Tokyo (JP)

(73) Assignee: Oki Electric Industry Co., Ltd., Tokyo (JP)

(21) Appl. No.: 18/415,312

(22) Filed: Jan. 17, 2024

(30) Foreign Application Priority Data
Mar. 13, 2023 (JP) 2023-038427

(51) Int. Cl. G03G 15/08

(52) U.S. Cl. CPC G03G 15/0896

(57) ABSTRACT

An image formation apparatus according to an embodiment may include: development devices; and transmission gear members each including an output gear portion engaged with a drive gear portion of the corresponding development device. Among adjacent first and second development devices, a smallest angle θ1 of angles of gear teeth on a first output gear portion corresponding to the first development device in a rotation direction is different from a smallest angle θ2 of angles of gear teeth on a second output gear portion corresponding to a second development device in the rotation direction.

### CROSS REFERENCE TO RELATED APPLICATIONS

This application claims priority based on 35 USC 119 from prior Japanese Patent Application No. 2023-38427 filed on Mar. 13, 2023, entitled “IMAGE FORMATION APPARATUS AND METHOD FOR MANUFACTURING IMAGE FORMATION APPARATUS”, the entire contents of which are incorporated herein by reference.

### BACKGROUND

The disclosure may relate to an image formation apparatus, particularly to an image formation apparatus including a plurality of development devices and a method for manufacturing the image formation apparatus.

In a related art, an image formation apparatus having a plurality of development devices is known. (see, Patent Document 1, for example)
Patent Document 1: Japanese Patent Application Publication No. 2022-178918 (see Page 7, FIG. 1)

### SUMMARY

However, jitter may occur due to the influence of gears driving the development devices, and there is a need to suppress the jitter occurrence, but it has been difficult to suppress jitter. An embodiment of the disclosure is to provide an image formation apparatus that can more easily suppress jitter, compared to a conventional image formation apparatus.

An aspect of the disclosure may be an image formation apparatus that may include: a plurality of development devices that are provided in a main body of the apparatus and each include a drive gear portion; and a plurality of transmission gear members provided corresponding to the plurality of development devices. Each of the plurality of transmission gear members include an output gear portion that is engaged with the drive gear portion of the corresponding development device and configured to output drive force of a drive source. The plurality of development devices includes a first development device and a second development device that are adjacent to each other. When a virtual line connecting a rotation center of a first output gear portion, which is the output gear portion corresponding to the first development device, and a rotation center of the corresponding drive gear portion is referred to as a first virtual line and a virtual line connecting a rotation center of a second output gear portion, which is the output gear portion corresponding to the second development device, and a rotation center of the corresponding drive gear portion is referred to as a second virtual line, a smallest angle θ1 of rotation angles of gear teeth on the first output gear portion in a rotation direction with respect to the first virtual line is different from a smallest angle θ2 of rotation angles of gear teeth on the second output gear portion in a rotation direction with respect to the second virtual line.

Another aspect of the disclosure may be a method for manufacturing an image formation apparatus. The method may include: preparing a plurality of transmission gear members each formed of a multi-stage gear including an output gear portion and an input gear portion having more gear teeth than the output gear portion; attaching a first transmission gear member that is any one of the plurality of transmission gear members to a main body of an image formation apparatus; attaching a second transmission gear member that is anyone of the plurality of transmission gear members to the main body of the image formation apparatus; determining and maintaining, by using a jig, a gear teeth phase difference between a first output gear portion of the first transmission gear member and a second output gear portion of the second transmission gear member; arranging gear rows between a drive source and the plurality of transmission gear members in which the phase difference is maintained; and removing the jig.

According to at least one of the above aspects, since the vibration generated by the transmission of the drive force to the drive gear portions of the development devices can be suppressed by vibration interference, the shading stripes (jitter) of a printed image caused by this vibration can be suppressed.

### BRIEF DESCRIPTION OF DRAWINGS

FIG. 1 is a schematic configuration diagram illustrating a main configuration of an image formation apparatus according to a first embodiment.

FIG. 2 is a diagram illustrating an exterior perspective view, seen diagonally from below, of four image formation units arranged in order from the upstream side of the sheet conveyance direction with a rotary drive system that transmits rotational force to each photosensitive drum.

FIGS. 3A to 3I illustrate the process by which one gear tooth on a drum side gear of a double gear rotates and shifts step by step in the counterclockwise direction to a position of a next adjacent gear tooth in nine stages. Here, the drum side gear of the double gear after the rotation is illustrated by the solid lines, and the gear teeth on the drum side gear of the double gear at the position (reference position) before the rotation are illustrated by the dotted lines.

FIG. 4 is a diagram for explaining the relationship between the number of gear teeth on the drum side gear and the number of gear teeth on a motor side gear that constitute the double gear.

FIG. 5A is a diagram for explaining setting shift amounts of the four double gears using an assembly jig, and FIGS. 5B to 5E are partial enlarged views each illustrating an engagement portion of each of the double gears.

FIG. 6A is a diagram for explaining a stage of attaching a first idle gear and a second idle gears while the assembly jig is attached, and FIG. 6B is a diagram for explaining a stage of removing the assembly jig.

FIG. 7 is a diagram for explaining the phase shift amount n.

FIGS. 8A and 8B are graphs indicating results obtained by simulation regarding relationship of amplitude ratios of a case where the vibration of each photosensitive drum when the rotary drive system is operated is combined using a phase shift amount n as a variable, wherein FIG. 8A is for the four photosensitive drums, and FIG. 8B is for the two adjacent photosensitive drums.

FIGS. 9A to 9C are graphs that analyze intensity distribution of shading stripes (jitter) of a halftone print image printed using the image formation apparatus set so that the phase shift amount n becomes as n=½ and compare with a case where the phase shift amount n is 0, wherein FIG. 9A indicates measurement results of a case of printing a single color of black (K), FIG. 9B indicates measurement results of a case of printing a single color of magenta (M), and FIG. 9C indicates measurement results of a case of four-color mixed printing of black (K), yellow (Y), magenta (M), and cyan (C).

FIG. 10 is a diagram illustrating a main configuration of an image formation apparatus according to a first modification of an embodiment.

FIG. 11 is a diagram illustrating a main configuration of an image formation apparatus according to a second modification of an embodiment.

FIG. 12 is a diagram illustrating a main configuration of an image formation apparatus according to a third modification of an embodiment.

FIG. 13 is a graph showing results obtained by simulation regarding relationship of amplitude ratios of a case where the vibration of each photosensitive drum when the rotary drive system is operated is combined using a phase shift amount n as a variable.

### DETAILED DESCRIPTION

Descriptions are provided hereinbelow for one or more embodiments based on the drawings. In the respective drawings referenced herein, the same constituents are designated by the same reference numerals and duplicate explanation concerning the same constituents is omitted. All of the drawings are provided to illustrate the respective examples only.

### First Embodiment

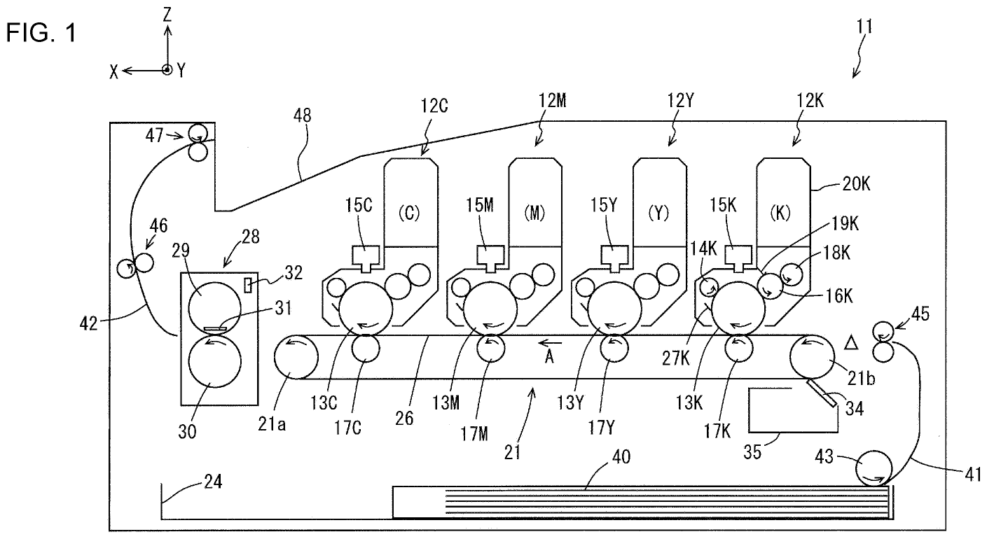

FIG. 1 is a schematic configuration diagram illustrating a main configuration of an image formation apparatus 11 according to a first embodiment.

The image formation apparatus 11 includes, for example, a configuration as an electrophotographic color printer, and image formation units 12K, 12Y, 12M, and 12C as four independent development devices (may be simply referred to as an image formation unit 12 unless it is particularly necessary to distinguish between them) that constitute an image formation section are arranged along a conveyance direction of recording paper 40 as a recording medium (in the direction indicated by the arrow A) in order from upper stream.

The image formation unit 12K forms a black (K) image, the image formation unit 12Y forms a yellow (Y) image, the image formation unit 12M forms a magenta (M) image, and the image formation unit 12C forms a cyan (C) image. In addition to the recording paper 40, a transparency film, an envelope, copy paper, special paper, and the like can be used as the recording medium.

Since each of the image formation units 12K, 12Y, 12M, and 12C has the same configuration except for the color of the developer used, the configuration of the image formation unit 12K will be described here as an example.

The image formation unit 12K includes a photosensitive drum 13K as an image carrier, a charging roller 14K that uniformly and evenly charges the surface of the photosensitive drum 13K, and a development roller 16K that causes an unillustrated developer (for example, toner) to be attached to an electrostatic latent image formed on the surface of the photosensitive drum 13K to form a toner image that is a visible image, a toner supply roller 18K that is pressed in contact with the development roller 16K, and a cleaning blade 27K that removes toner remaining on the photosensitive drum 13K after transfer.

The toner supply roller 18K is a roller that supplies, to the development roller 16K, toner supplied from a corresponding toner cartridge 20K detachably attached to the image formation unit body. A development blade 19K is pressed against the development roller 16K. The development blade 19K makes a thin layer of the toner supplied from the toner supply roller 18K on the development roller 16K. Here, the toner cartridge 20K is detachably attached to the main body of the image formation unit 12K.

Note that each component member of the image formation unit 12K is marked with (K) at the end of the reference numeral, but each corresponding component member of the image formation unit 12Y, the image formation unit 12M, and the image formation unit 12C is distinguished by (Y), (M), and (C), respectively; however, the letters are not marked when there is particularly no need of distinguishing.

Above the photosensitive drums 13K, 13Y, 13M, 13C in each image formation unit 12K, 12Y, 12M, and 12C, the corresponding LED heads 15K, 15Y, 15M, and 15C (may simply be referred to as an LED head 15 unless there is a particular need of distinguishing) are respectively disposed in positions corresponding to the photosensitive drums 13K, 13Y, 13M, and 13C. Each LED head 15 is a device that exposes the photosensitive drum 13 according to the image data of the corresponding color to form an electrostatic latent image.

Below the photosensitive drums 13 of the four image formation units 12, a transfer unit 21 is disposed. The transfer unit 21 includes transfer rollers 17K, 17Y, 17M, and 17C (also simply referred to as a transfer roller 17 when there is no need of distinguishing), and a transfer belt 26 that is provided so as to travel toward the direction indicated by the arrow A in FIG. 1 in a state of being stretched by a transfer belt drive roller 21a and a transfer belt driven roller 21b.

Each transfer roller 17 is disposed so as to pressed-contact the corresponding photosensitive drum 13 via the transfer belt 26, the recording paper 40 is charged to the opposite polarity to the toner at this nip portion, and toner images of each color formed on the corresponding photosensitive drums 13 are transferred onto the recording paper 40 in an overlapped manner.

In the lower part of the image formation apparatus 11, a paper feed mechanism for supplying recording paper 40 to the transfer belt 26 is disposed. The paper feed mechanism includes a hopping roller 43, a resist roller pair 45, a paper storage cassette 24, and the like.

Further, a fixation device 28 is provided on the discharge side of the recording paper 40 discharged by the transfer belt 26. The fixation device 28 includes a heating roller 29 and a backup roller 30, and is a device for fixing toner transferred on the recording paper 40 by pressurizing and heating. In the discharge side, a conveyance roller pair 46 and a discharging roller pair 47 which are disposed along a sheet guide 42, and a sheet stacker 48 are provided.

The printing operation in the image formation apparatus 11 configured as described above will be briefly described. First, the recording paper 40 in a paper storage cassette 24 is rolled out to a sheet guide 41 by the hopping roller 43, sent to the resist roller pair 45 to correct the oblique line, and then sent from the resist roller pair 45 to the transfer belt 26. Due to the traveling of the transfer belt 26, the recording paper 40 is conveyed to the image formation unit 12K, 12Y, 12M, and 12C sequentially.

On the other hand, in each image formation unit 12, the surface of the photosensitive drum 13 is charged by the charging roller 14 and then exposed by the corresponding LED head 15, and an electrostatic latent image is formed on the surface by this exposure. In the portion where the electrostatic latent image is formed, a thinly layered toner is electrostatically attached on the development roller 16 to form a toner image of the corresponding color.

The toner image formed on each of the photosensitive drums 13 is sequentially transferred to the recording paper 40 by the corresponding transfer rollers 17 to form a color toner image on the recording paper 40. After the transfer, the toner remaining on each photosensitive drum 13 is removed by the cleaning blade 27, respectively.

The recording paper 40 on which the color toner image is formed is sent to the fixation device 28. In the fixation device 28, the color toner image is fixed on the recording paper 40 and a color image is formed. The recording paper 40 on which the color image is formed is conveyed along the sheet guide 42 by the conveyance roller pair 46, and is discharged to the paper stacker 48 by the discharge roller pair 47. Through the above process, a color image is formed on the recording paper 40. The remained toner adhering to the transfer belt 26 is removed by a belt cleaning blade 34 and stored in a belt cleaner container 35.

Regarding the X, Y, and Z directions of FIG. 1, the conveyance direction (the arrow A direction) when the recording paper 40 passes through the image formation units 12K, 12Y, 12M, and 12C is the X direction, and the rotation axis direction of the photosensitive drums 13K, 13Y, 13M, and 13C is the Y direction, and the direction perpendicular to these two axes is the Z direction. The X, Y, and Z directions are also illustrated in the other figures described below, indicating the same directions as in FIG. 1. In other words, the X, Y, and Z directions in each figure indicate the directions of arrangement of the image formation apparatus 11 illustrated in FIG. 1. Note that the Z direction is oriented in a substantially vertical direction.

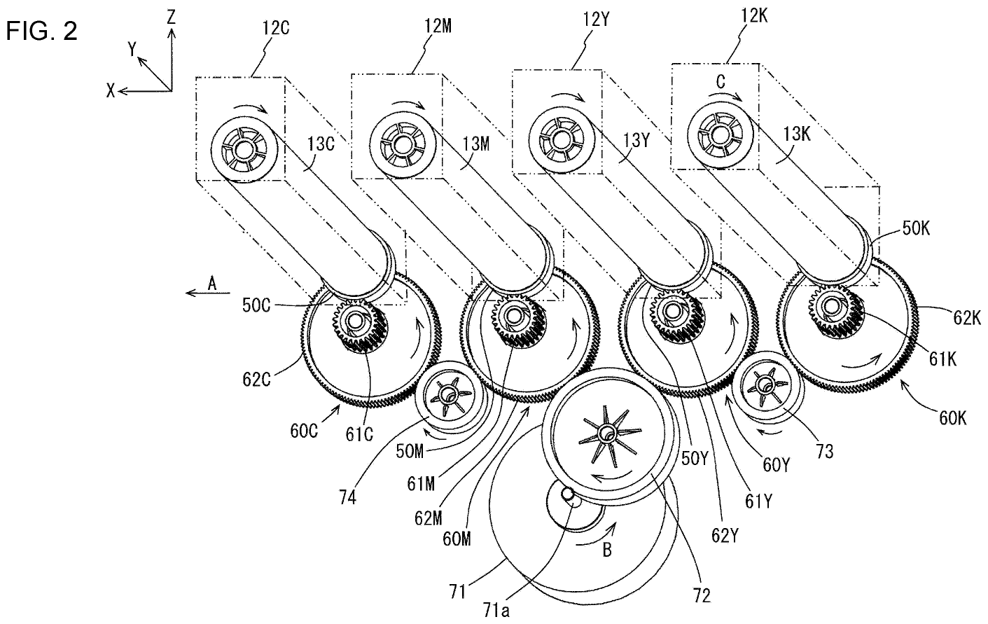

FIG. 2 is a diagram illustrating an exterior perspective view, seen diagonally from below, of the four image formation units 12K, 12Y, 12M, and 12C arranged in order from the upstream side of the sheet conveyance direction (the arrow A direction) with a rotary drive system that transmits rotational force to each photosensitive drum 13. In the figure, each image formation unit 12 is illustrated with only each photosensitive drum 13, and its exterior schematic figure is illustrated by two-dot chain lines.

The rotary drive system includes a drive motor 71 as a drive source with a motor gear 71a formed on its rotation axis, a first idle gear 72, two second idle gears 73 and 74, four double gears 60K, 60Y, 60M, and 60C as transmission gear members (simply referred to as a double gear 60 when there is no particular need of distinguishing), and drive gears 50K, 50Y, 50M, and 50C (simply referred to as a drive gear 50 when there is no particular need of distinguishing) as drive gear portions integrally arranged coaxially at the end of each photosensitive drum 13.

The first idle gear 72 is engaged with the motor gear 71a integrally formed on the rotation axis of the drive motor 71 and motor side gears 62Y and 62M, which are larger-diameter gears of the two double gears 60Y and 60M respectively, and transmits rotary drive force of the drive motor 71 to the tow double gears 60Y and 60M.

A drum side gear 61Y, which is a smaller-diameter gear of the double gear 60Y, is engaged with the drive gear 50Y and transmits the rotary drive force of the drive motor 71 to the photosensitive drum 13Y of the image formation unit 12Y, and the drum side gear 61M, which is a smaller-diameter gear of the double gear 60M, is engaged with the drive gear 50M and transmits the rotary drive force of the drive motor 71 to the photosensitive drum 13M of the image formation unit 12M.

The second idle gear 73 is engaged with the motor side gears 62K and 62Y, which are the larger-diameter gears of the two double gears 60K and 60Y respectively, and transmits the rotary drive force of the drive motor 71 to the double gear 60K. The second idle gear 74 is engaged with the motor-side gears 62M and 62C, which are the larger-diameter gears of the two double gears 60M and 60C respectively, and transmits the rotary drive force of the drive motor 71 to the double gear 60C.

A drum side gear 61K, which is a smaller-diameter gear of the double gear 60K, is engaged with the drive gear 50K and transmits the rotary drive force of the drive motor 71 to the photosensitive drum 13K of the image formation unit 12K. A drum side gear 61C, which is a smaller-diameter gear of the double gear 60C, is engaged with the drive gear 50C and transmits the rotary drive force of the drive motor 71 to the photosensitive drum 13C of the image formation unit 12C.

Therefore, when the motor gear 71a of the drive motor 71 rotates in the arrow B direction at a predetermined rotation speed, each of the photosensitive drums 13 eventually rotates in the arrow C direction at a predetermined rotation speed. Here, the number of teeth on the two second idle gears 73 and 74 is the same, the number of teeth on each of the drum side gears 61K, 61Y, 61M, and 61C as four output gear portions is the same, and the number of teeth on each of the motor side gears 62K, 62Y, 62M, and 62C as the four input gear portions is the same.

Further, as illustrated in FIG. 2, the drum side gear 61 and the motor side gear 62 of the double gear 60 are formed in different regions from each other in the rotation axis direction of the double gear 60.

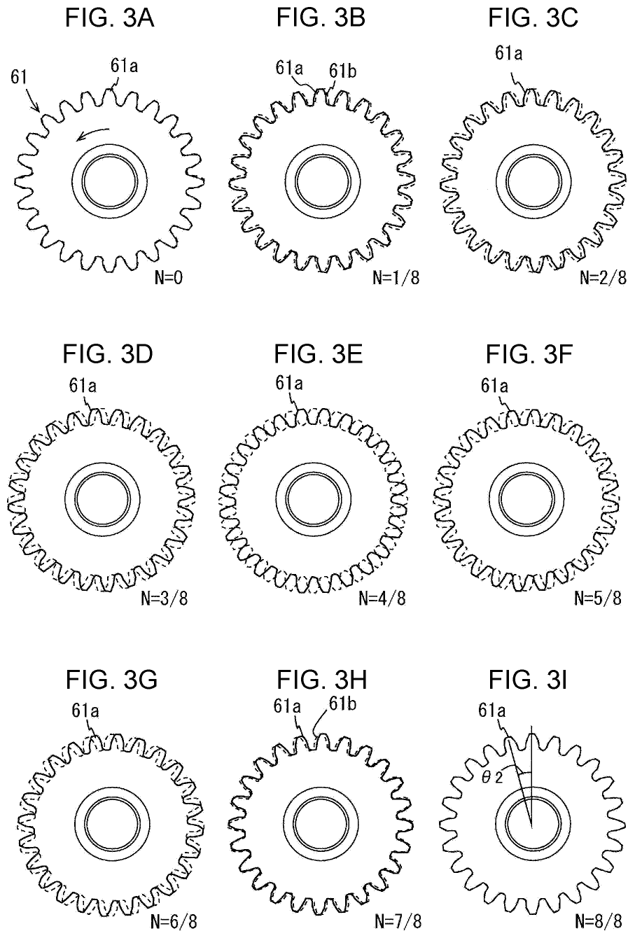

Here, a phase shift amount n is defined regarding the phase shift of the adjacent two double gears 60. FIGS. 3A to 3I illustrate the process by which one gear tooth on the drum side gear 61 which is the smaller-diameter gear of the double gear 60 rotates and shifts step by step in the counterclockwise direction to a position of the next adjacent gear tooth in nine stages. Here, the drum side gear 61 of the double gear 60 after the rotation is illustrated by the solid lines, and the gear teeth on the drum side gear 61 of the double gear 60 at the position (reference position) before the rotation are illustrated by the dotted lines.

FIG. 3A illustrates a state in which a specific gear tooth 61a of the drum side gear 61 is in a reference position, and the phase shift amount n at this time is expressed as [n=0]. FIG. 3I illustrates a state when the particular gear tooth 61a moves to the position of the next adjacent gear tooth, and the phase shift amount n at this time is expressed as [n=1].

Further, with respect to the rotation angle (360[°]) of one full rotation of the drum side gear 61, when the rotation angle between the adjacent gear teeth of the drum side gear 61 (hereinafter, referred to as the rotation angle per cycle of the gear teeth) is 0 and the number of gear teeth of the drum side gear 61 is Z1, the following equation is obtained.

$$θ = 360 [ ° ] / Z 1 \qquad Equation ( 1 )$$

FIGS. 3(b) to 3(h) respectively illustrate a state in which the specific gear tooth 61a is deviated from the reference position illustrated in FIG. 3(a) in the counterclockwise direction in the respective figures by a rotation angle (θ/8). For this reason, the phase shift amount n in FIG. 3(b) is [n=⅛], the phase shift amount n in FIG. 3(c) is [n=2/8], the phase shift amount n in FIG. 3(d) is [n=⅜], the phase shift amount n in FIG. 3(e) is [n=4/8], the phase shift amount n in FIG. 3(f) is [n=⅝], the phase shift amount n in FIG. 3(g) is [n=6/8], and the phase shift amount n in FIG. 3(h) is [n=⅞]. The deviation from n=0 to n=1 is considered as one cycle. When the phase shift amount n is [n=4/8=½], a reverse phase state occurs in which the bottom lands of the gear teeth overlap with the top lands of the gear teeth at the reference (dotted lines).

Here, since the phase shift amount of a pair of periodically formed waveforms is a matter, even if a specific gear tooth 61a shifts greater than 0, the phase shift amount n repeats 0 to 1 in the same manner while 1 corresponds to 0.

Further, although the phase shift direction is defined as positive in the counterclockwise direction in the figure, the clockwise direction in the figure may be defined to be positive as long as the direction is unified in the applied device. The two double gears 60 here indicate two double gears 60 corresponding to the adjacent image formation units 12 illustrated in FIG. 2, and the relationship between the double gears 60 are defined in Table 1.

TABLE 1

| | | | | |
|---|---|---|---|---|
| COLOR OF ONE OF DOUBLE GEARS 60 | C | M | Y | K |
| COLOR OF THE OTHER OF DOUBLE GEARS 60 | M | Y | K | — |
| (RIGHT SIDE) | | | | |
| COLOR OF THE OTHER OF DOUBLE GEARS 60 | — | C | M | Y |
| (LEFT SIDE) | | | | |

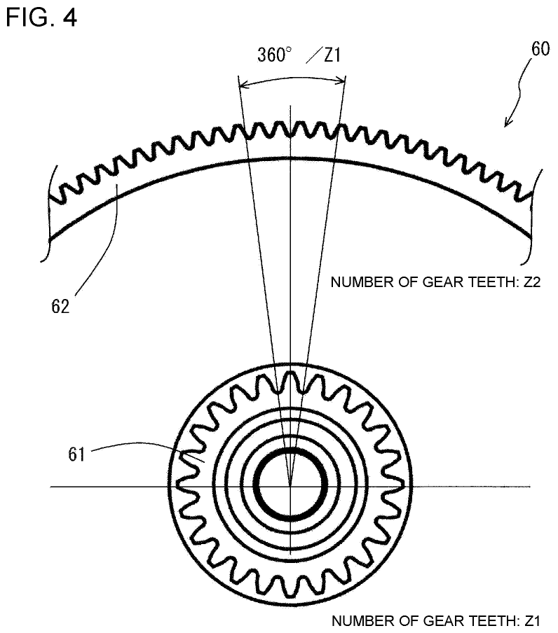

FIG. 4 is a diagram for explaining the relationship between the number of gear teeth on the drum side gear 61 and the number of gear teeth on the motor side gear 62, which constitute the double gear 60.

According to an embodiment, when the number of gear teeth on the drum side gear 61 illustrated in FIG. 4 is Z1 and the number of gear teeth on the motor side gear 62 is Z2, the gear ratio X is expressed as

$$X = Z 2 / Z 1 \geq 4. \qquad Equation ( 2 )$$

In other words, the ratio of the number of teeth on the motor side is “4” or more with respect to the number of gear teeth “1” on the drum side gear 61.

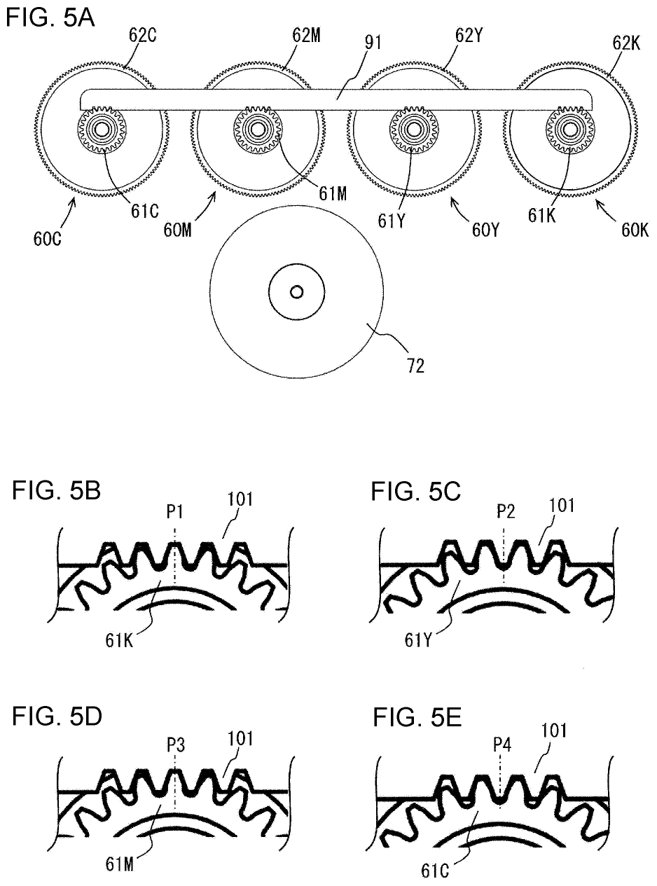

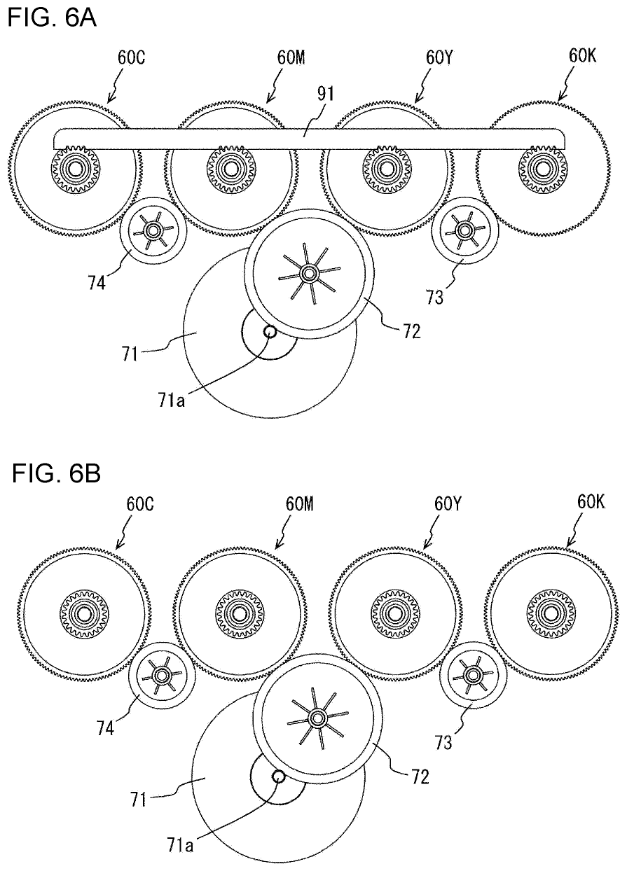

Next, how to assemble the drive motor 71 having the motor gear 71a, the first idle gear 72, the two second idle gears 73 and 74, and the four double gears 60K, 60Y, 60M, and 60C (simply referred to as double gears 60 when there is no particular need of distinguishing) that constitute the rotary drive system will be described with reference to FIGS. 5A to 6B.

FIG. 5A is a diagram for explaining setting the shift amounts of the four double gears 60 using an assembly jig 91 as a jig, and FIGS. 5B to 5E are partial enlarged views of the engagement portions of each double gear 60. FIG. 6A is a diagram explaining a stage of attaching the first idle gear 72 and the second idle gears 73 and 74 while the assembly jig 91 is attached, and FIG. 6B is a diagram for explaining a stage of removing the assembly jig 91.

First, as illustrated in FIG. 5A, the four double gears 60 having the drum side gears 61 are arranged at predetermined intervals from each other at a predetermined location in the image formation apparatus 11, and the assembly jig 91 is attached so as to engage with each of the drum side gear 61 to set the phase shift amount n. The above description corresponds to the first to third steps, and this shift amount is set before attaching the four image formation units 12.

The assembly jig 91 has rack gear portions 101 that are respectively engaged with the drum side gears 61 as illustrated in FIGS. 5B to 5E. Each of the rack gear portions 101 includes a rack portion formed so as to be engaged with a top land of the drum side gear 61K at an engagement point P1 at the double gear 60K as illustrated in FIG. 5B, a rack portion formed so as to be engaged with a bottom land of the drum side gear 61Y at an engagement point P2 at the double gear 60Y adjacent to the left side of the double gear 60K as illustrated in FIG. 5C, a rack portion formed so as to be engaged with a top land of the drum side gear 61M at an engagement point P3 at the double gear 60M adjacent to the left side of the double gear 60Y as illustrated in FIG. 5D, and a rack portion formed so as to be engaged with a bottom land of the drum side gear 61C at an engagement point P4 at the double gear 60C adjacent to the left side of the double gear 60M as illustrated in FIG. 5E.

In other words, the four double gears 60 are set so that the phase shift amount n between the adjacent pair of drum side gears 61 is set as n=½ in the process when the assembly jig 91 is installed. With the assembly jig 91 attached in this manner, as illustrated in FIG. 6A, the first idle gear 72 is attached so as to engage with the motor side gear 62Y of the double gear 60Y, the motor side gear 62M of the double gear 60M, and the motor gear 71a of the drive motor 71, the second idle gear 73 is attached so as to engage with the motor side gear 62K of the double gear 60K and the motor side gear 62Y of the double gear 60Y, and the second idle gear 74 is attached so as to engage with the motor side gear 62M of the double gear 60M and the motor side gear 62C of the double gear 60C. The step of attaching each idle gear here corresponds to the fourth step.

As described above, a rotary drive system composed of gears from the drive motor 71 to the four double gears 60 is connected. Finally, as illustrated in FIG. 6B, the assembly jig 91 is removed and the assembly process of the rotary drive system ends. The step of removing the assembly jig 91 here corresponds to the fifth step.

Here, the assembly error that occurs when assembling the above-mentioned rotary drive system will be considered. As illustrated in FIG. 6, at the stage of attaching the first idle gear 72 and the second idle gears 73 and 74, these idle gears are fitted within the range of errors generated by backlash such as flexing of each member and lifting of the assembly jig 91.

The maximum rotation angle range of the error generated at this time is +(1/(2X)×θ) with the gear ratio X of the gear tooth number Z2 of the motor side gear 62 with respect to the gear tooth number Z1 of the drum side gear 61 obtained by the above Equation (2). Therefore, when the assembly jig 91 that can fix the phase shift between the adjacent drum side gears 61 to ½ is used, the error range of the phase shift amount n is ½−1/(2X)≤n≤½+1/(2X) . . . Equation (3).

For example, when the gear ratio X is as X=4, the error range of the phase shift amount n is ⅜≤ n≤⅝ centered on ½.

Therefore, based on the above Equation (3), when the gear ratio X is at least set to be greater than 1, that is, the number of gear teeth Z2 on the motor side gear 62 is set more than the number of gear teeth Z1 on the drum side gear 61, the error range of the phase shift amount n can be maintained lower than ±½ and a phase difference can be set between adjacent drum side gears 61.

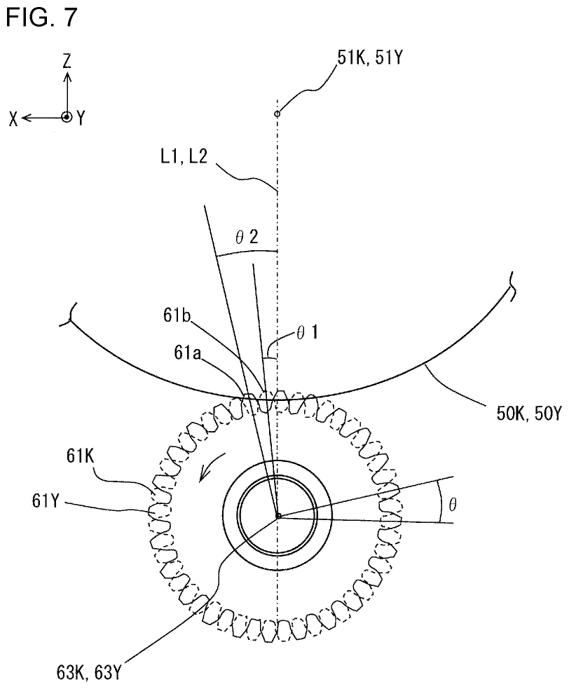

Here, the phase shift amount n will be further described. FIG. 7 is a diagram for explaining the phase shift amount n.

FIG. 7 is a schematic diagram illustrating, viewed from the positive side of the Y axis in a superimposed manner, the drum side gear 61K as the first output gear portion of the double gear 60K and the drive gear 50K of the photosensitive drum 13K, and the drum side gear 61Y as the second output gear portion of the double gear 60Y adjacent to the double gear 60K and the drive gear 50Y of the photosensitive drum 13Y. Therefore, the first virtual line L1 connecting a rotation center 63K of the drum side gear 61K and a rotation center 51K of the drive gear 50K, and the second virtual line L2 connecting a rotation center 63Y of the drum side gear 61Y and a rotation center 51Y of the drive gear 50Y overlap.

Here, when, in the rotation angle of the drum side gear 61K with respect to the first virtual line L1, the rotation angle of the specific gear tooth 61a on the drum side gear 61K, which is the smallest angle of the gear tooth rotation angles, is θ1 and, in the rotation angle of the drum side gear 61Y with respect to the second virtual line L2, the specific gear tooth 61b on the drum side gear 61Y, which is the smallest angle of the gear tooth rotation angles, is θ2, the phase shift amount n is as n=|θ2−θ1|/θ . . . . Equation (4).

Further, in this example, the relationship of the phase shift amount n between the drum side gear 61K of the double gear 60K and the drum side gear 61Y of the double gear 60Y has been described. Similarly, when it is assumed that the rotation angle of the smallest gear tooth of the rotation angles of the gear teeth on the drum side gear 61M is θ3, and the rotation angle of the smallest gear teeth of the rotation angles of the gear teeth on the drum side gear 61C is θ4, the phase shift amount n between the drum side gear 61M and the drum side gear 61Y is as n=|θ3−θ2|/θ, and the phase shift amount n between the drum side gear 61C and the drum side gear 61M is as n=|θ4−θ3|/θ.

Further, when it is assumed that the rotation angle of any first rotation angle position between any adjacent gear teeth of the drum side gear 61K from the first virtual line L1 is θa, the number of teeth from the first virtual line L1 to the first rotation angle position is Ca, and the rotation angle from the center of the gear tooth on the first virtual line L1 side of the pair of gears to the first rotation angle position is θ1, θa is expressed as θa=Cb×θ+θ1.

On the other hand, when it is assumed that the rotation angle of any second rotation angle position between any adjacent gear teeth of the drum side gear 61Y from the second virtual line L2 is Ob, the number of teeth from the second virtual line L2 to the second rotation angle position is Cb, and the rotation angle from the center of the gear tooth on the second virtual line L2 side of the pair of gears to the second rotation angle position is θ2, θb is expressed as θb=Cb×θ+θ2. θ here is expressed as θ=360[°]/Z1 based on the above Equation (1).

Therefore, the rotation angle difference Δθ between the first rotation angle position and the second rotation angle position is expressed as Δθ=θb−θa=(Cb×θ+θ2)−(Ca×θ+θ1), but since the phase difference between the first rotation angle position and the second rotation position is |θ2−θ1|, the phase shift amount n here can also be obtained by the above Equation (4).

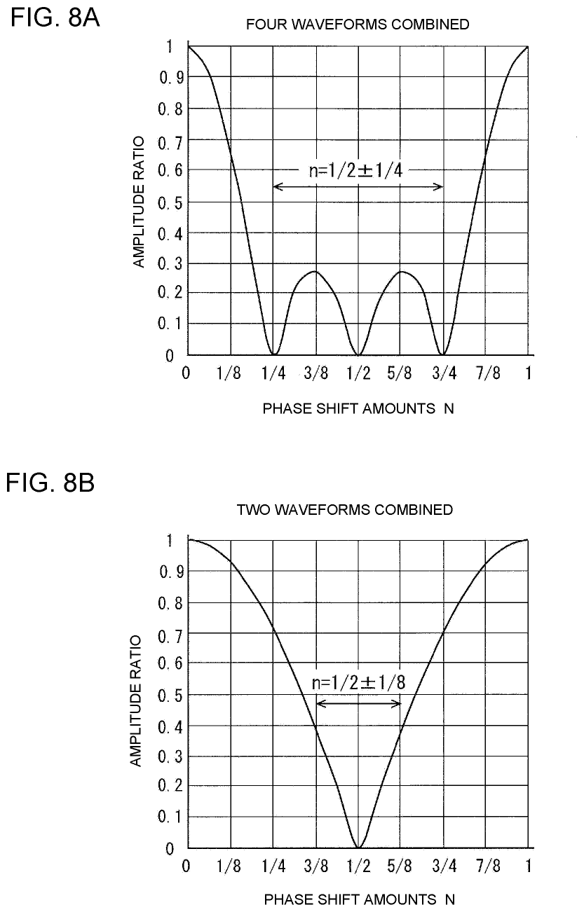

FIGS. 8A and B are graphs illustrating results of obtaining, by simulation, the amplitude ratio relationship when the rotary drive system from the drive motor 71 to the photosensitive drums 13 is operated and vibration of the respective photosensitive drums 13 is combined where the phase shift amount n between the drum side gears 61 of the adjacent double gear 60 is used as a variable. The vertical axis represents the amplitude ratios and the horizontal axis represents the phase shift amounts n.

FIG. 8A is for four photosensitive drums 13, and each of these photosensitive drums 13 alone is expected to generate vibrations synchronously with each other at the same amplitude and period, and the FIG. 8B is for two adjacent photosensitive drums 13, and each of these photosensitive drums 13 alone is expected to generate vibrations synchronously with each other at the same amplitude and period. The maximum amplitude of each simulation result was set to 1.

In this example, since the vibration generated in each photosensitive drum 13 is mainly caused by the engagement between the drum side gear 61 of the double gear 60 and the drive gear 50, the vibration cycle is set based on the timing at which each of these gear teeth engages.

As illustrated in FIG. 8A, according to the simulation results for the four photosensitive drums 13, it is found that, due to the vibration interference of the four photosensitive drums 13, the amplitude is 1, which is the maximum, when the phase shift amount n is 0 or 1, and each vibration is canceled and becomes 0 when the phase shift amount n is ¼, ½, or ¾. Furthermore, if the phase shift amount n is in the range of ¼≤ n≤¾, the amplitude ratio can be suppressed to 0.3 or less.

In order to obtain this result in the actual apparatus, as described above, the phase shift amount n between the adjacent drum side gears 61 is set as n=½ by using the assembly jig 91 and, from the above Equation (3), the gear ratio X (Z2/Z1) is set to 2 or more.

On the other hand, as illustrated in FIG. 8B, according to the simulation results for the two adjacent photosensitive drums 13, due to the vibration interference of the two photosensitive drums 13, the amplitude becomes 1, which is the maximum, when the phase shift amount n is 0 or 1, and each vibration is canceled and becomes 0 when the phase shift amount n is ½. Furthermore, if the phase shift amount n is in the range of ⅜≤n≤⅝, the amplitude ratio can be suppressed to 0.4 or less.

In order to obtain this result in the actual apparatus, as described above, the phase shift amount n between the adjacent drum side gears 61 is set as n=½ by using the assembly jig 91 and, from the above Equation (3), the gear ratio X (Z2/Z1) is set to 4 or more.

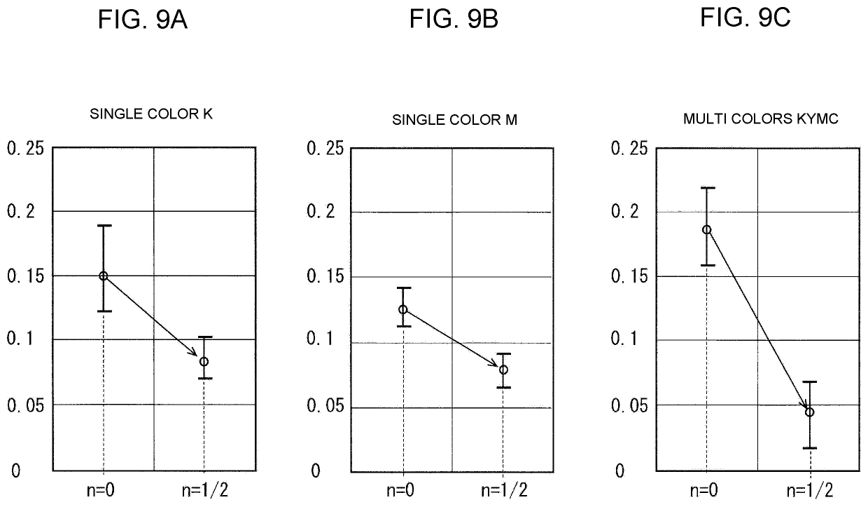

FIGS. 9A, 9B, and 9C are graphs in which the shading stripes (jitter) of the halftone print image printed using the image formation apparatus 11 that is set so that the phase shift amount n becomes as n=½ is processed by fast Fourier transform (FFT) in the sheet conveyance direction to analyze the intensity distribution of the frequency, and the intensity of the shading stripes of the gear pitch (here 2 [mm] to 3 [mm]) of the drum side gear 61 of the double gear 60 is compared with that in the case where the phase shift amount n is 0.

In FIGS. 9A to 9C, the vertical axis of each graph quantifies the intensity of the shading stripes, and the intensity is proportional to the numerical value. The measured values in each graph have variations in intensity for each measurement, but the average value is indicated by o (white circles).

FIG. 9A indicates the measurement results when black (K) is printed in a single color, and when the phase shift amount n is as n=½, the intensity of the shading stripes (jitter) is suppressed by about half compared to the case where n=0. FIG. 9B indicates the measurement results when magenta (M) is printed in a single color, and in this case as well, when the phase shift amount n is as n=½, the intensity of the shading stripes (jitter) is suppressed by about half compared to the case where n=0. FIG. 9C indicates the measurement results when the four colors of black (K), yellow (Y), magenta (M), and cyan (C) are printed in multiple colors, and in this case, when the phase shift amount n is as n=½, the intensity of the shade stripes (jitter) is suppressed to ¼ or less compared to the case where n=0.

The variation in the intensity of the shading stripes in single-color printing in FIGS. 9A and 9B is considered to be caused by variations in color development for each color and variations in vibration generation due to differences in the arrangement positions of the image formation units 12. Further, in the case of the four-color mixture in FIG. 9C, it seems that the shading stripes are less likely to appear due to the overlap of each color.

### First Modification

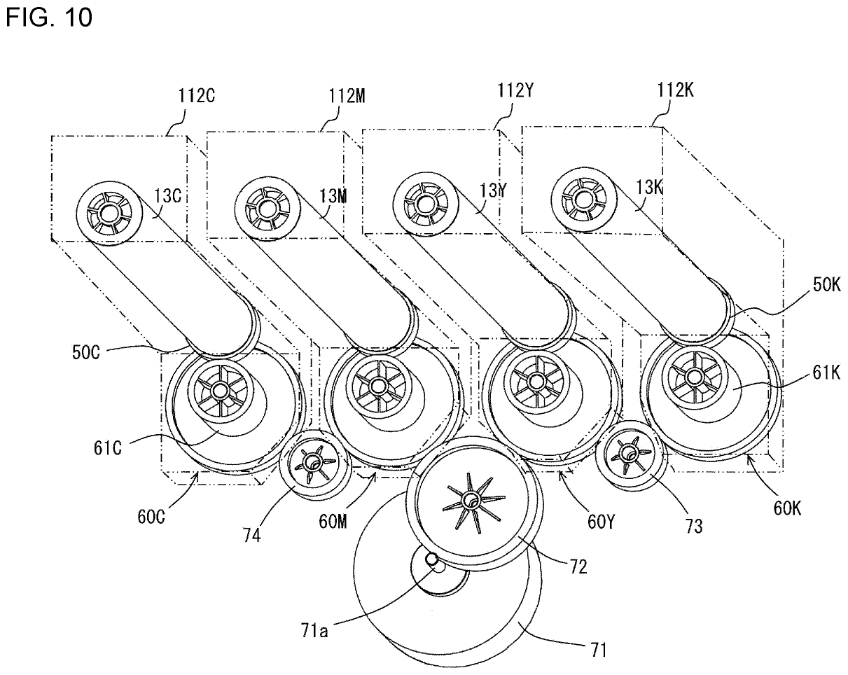

FIG. 10 is a diagram illustrating a main configuration of an image formation apparatus according to a first modification of an embodiment, and is an exterior perspective view, seen diagonally from below, of four image formation units 112K, 112Y, 112M, and 112C arranged in order from the upstream side in the sheet conveyance direction together with a rotary drive system that transfers rotary force to each of photosensitive drums 13. In the figure, only each of the photosensitive drums 13 is illustrated and the outline schematic diagram of each of the image formation units 112 is illustrated with a two-dotted chain lines.

As illustrated in the figure, each double gear 60 is disposed inside the corresponding image formation unit 112. In this modification, each image formation unit 112 is fixed to the image formation apparatus 11 body, and the setting of the deviation amount of the four double gears 60 is performed using a dedicated jig that enables setting the shift amount of the four double gears 60 before the four photosensitive drums 13 are installed. Here, the drive gear 50 formed at the end of the photosensitive drum 13 corresponds to the drive gear portion, and the drum side gear 61 of the double gear 60 engaged with the drive gear 50 corresponds to the output gear portion.

### Second Modification

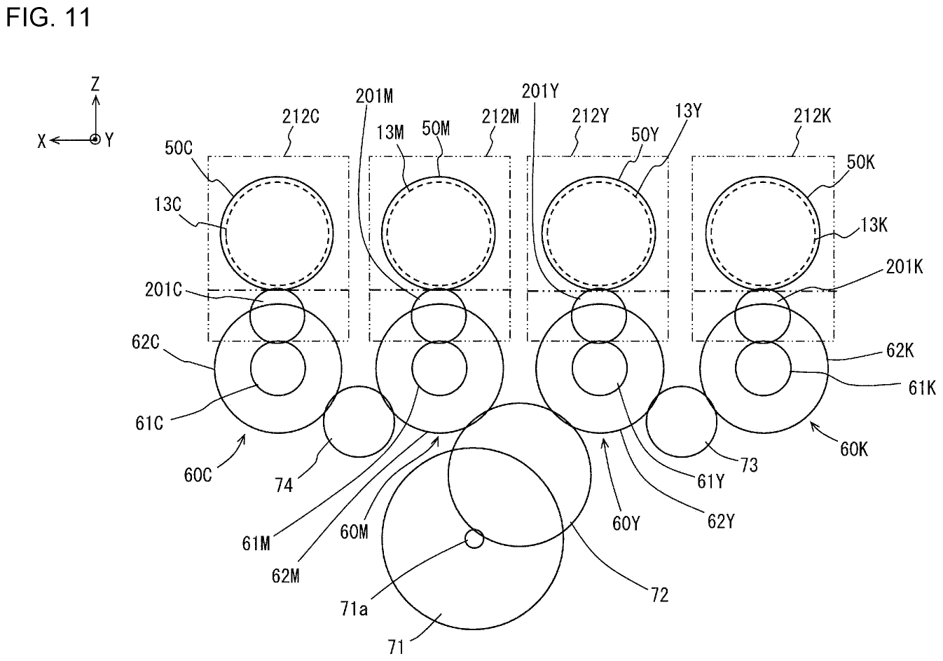

FIG. 11 is a diagram illustrating a main configuration of an image formation apparatus according to a second modification of an embodiment, and is a perspective view, seen from the positive side of the Y direction, of four image formation units 212K, 212Y, 212M, and 212C arranged in order from the upstream side in the sheet conveyance direction together with a rotary drive system that transfers rotary force to each of photosensitive drums 13. In the figure, only each of the photosensitive drums 13 is illustrated and the outline schematic diagram of each of the image formation units 212 is illustrated with a two-dotted chain lines.

As illustrated in the figure, here, a third idle gear 201 as a transmission gear is disposed between the drum side gear 61 of the double gear 60 and the drive gear 50 of the photosensitive drum 13 inside each image formation unit 212. With these third idle gears 201 provided, the degree of freedom in the arrangement of the rotary drive system in the image formation apparatus 11 increases.

In this second modification, it is assumed that the image formation unit 212 includes the idle gear 201, and that the image formation unit 212 is detachably attached to the image formation apparatus 11 body. In this case, the idle gear 201 corresponds to the drive gear portion, and the double gear 60 corresponds to the transmission gear member.

Here, it can be assumed that the idle gear 201 is provided to the main body of the image formation apparatus 11 without being included in the image formation unit 212, and that the image formation unit 212 not having the idle gear 201 is detachably attached to the main body of the image formation apparatus 11. In this case, the drive gear 50 corresponds to the drive gear portion, and the idle gear 201 corresponds to the transmission gear member.

Further, in a case where the image formation unit 212 is not detachable from the image formation apparatus 11 body, the drive gear 50 provided at the end of the photosensitive drum 13 corresponds to the drive gear portion, and the idle gear 201 corresponds to the transmission gear member.

### Third Modification

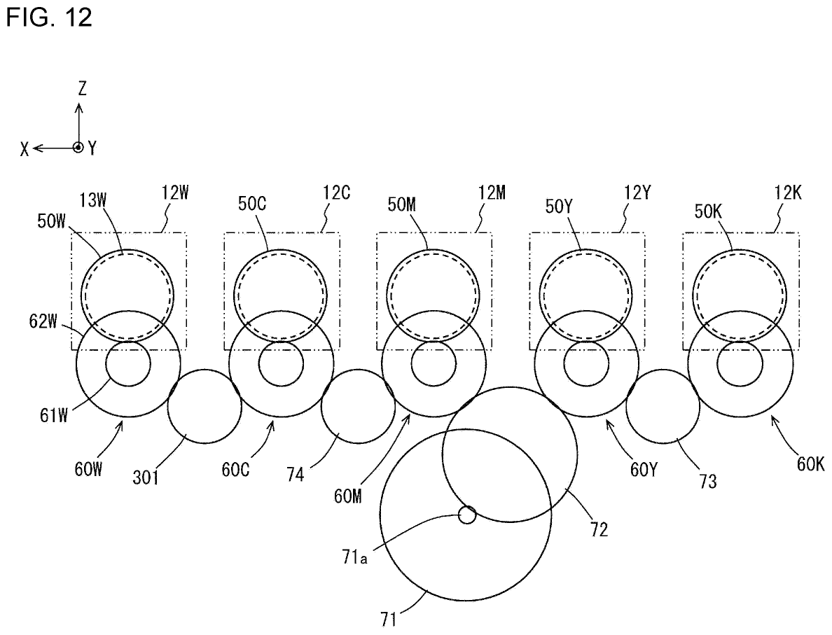

FIG. 12 is a diagram illustrating a main configuration of an image formation apparatus according to a third modification of an embodiment, and is a perspective view, seen from the positive side of the Y direction, of five image formation units 12K, 12Y, 12M, 12C, and 12W arranged in order from the upstream side in the sheet conveyance direction together with a rotary drive system that transfers rotary force to each of photosensitive drums 13. In the figure, each image formation unit 12 is illustrated with only each photosensitive drum 13, and its exterior schematic figure is illustrated by two-dot chain lines.

As illustrated in the figure, inside each image formation unit 212, a fifth image formation unit 12 that is an image formation unit 12W that forms a toner image of a color using a white (W) developer, for example, is arranged adjacent to the image formation unit 12C. The image formation unit 12W has the same configuration as the other image formation units 12 except for the color of the developer used, and a drive gear 50W is integrally disposed coaxially at the end of a photosensitive drum 13W.

In order to transmit rotational force to the photosensitive drum 13W, a double gear 60W and a second idle gear 301 are further provided. The double gear 60W is arranged so that its drum side gear 61W engages with the drive gear 50W of the corresponding photosensitive drum 13W as well as other double gears 60, and the second idle gear 301 is arranged to engage with the motor side gears 62C and 62W of the double gear 60C and 60W. With this configuration, the rotation of the drive motor 71 is transmitted to the image formation unit 12W.

Here, the drum side gear 61W of the double gear 60W is set so that the phase shift amount n with respect to the drum side gear 61C of the adjacent double gear 60C is the same as the shift amounts between the other adjacent drum side gears 61.

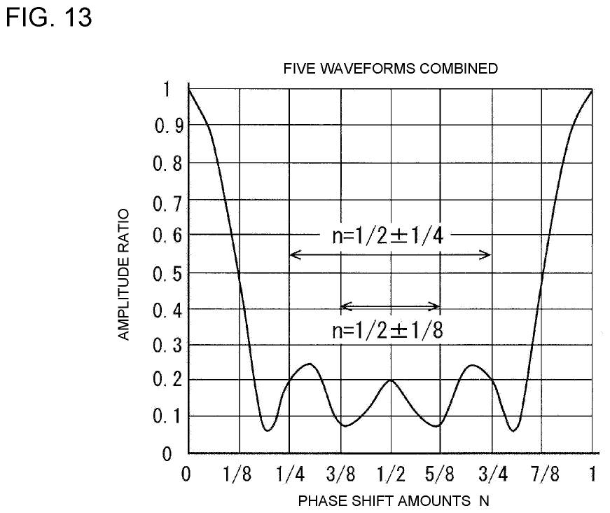

FIG. 13 is a graph illustrating results of obtaining, by simulation, the amplitude ratio relationship when the rotary drive system from the drive motor 71 to the photosensitive drums 13 is operated and vibration of the respective photosensitive drums 13 is combined where the phase shift amount n between the drum side gears 61 of the adjacent double gear 60 is used as a variable. The vertical axis represents the amplitude ratios, and the horizontal axis represents the phase shift amounts n, as described above. Regarding the five photosensitive drums 13, it is assumed that each of these photosensitive drums 13 alone generates vibrations synchronously with the same amplitude and period, and the maximum amplitude according to the simulation result is 1.

As illustrated in the figure, according to the simulation results for the five photosensitive drums 13, due to the vibration interference of the five photosensitive drums 13, the amplitude is 1, which is the maximum, when the phase shift amount n is 0 or 1, and the amplitude ratio is 0.1 or less in the four local minimal points between the above maximum points. Further, if the phase shift amount n is in the range of ¼≤ n≤¾, the amplitude ratio can be suppressed to 0.3 or less.

In order to obtain this result in the actual apparatus, as described above, the phase shift amount n between the adjacent drum side gears 61 is set as n=½ by using the assembly jig 91 and, from the above Equation (3), the gear ratio X (Z2/Z1) is set to 2 or more. Furthermore, if the phase shift amount n is in the range of ⅜≤ n≤⅝, the amplitude ratio can be suppressed to 0.2 or less.

In order to obtain this result in the actual apparatus, as described above, the phase shift amount n between the adjacent drum side gears 61 is set as n=½ by using the assembly jig 91 and, from the above Equation (3), the gear ratio X (Z2/Z1) is set to 4 or more.

According to an embodiment, an example in which the invention is applied to an image formation apparatus 12 having four or five image formation units 12 has been described; however, the invention is not limited the example, and can be applied to an image formation apparatus equipped with thee or less, or six or more image formation devices.

Furthermore, it can also be an image formation apparatus for monochrome printing. However, in this case, in addition to one image formation unit for a single color, a dummy unit equipped with only a dummy photosensitive drum that does not require a development function is prepared, for example, and each photosensitive drum is rotationally driven with setting of the above-described phase shift amount n.

As described above, regarding the image formation apparatus according to an embodiment, since the vibration generated in each of the photosensitive drums 13 of the plurality of image formation units 12 can be suppressed by mutual vibration interference and this can suppress the shade stripes (jitter) on printed image cased by vibration of the photosensitive drums 13.

In description of an embodiment, the words “above”, “below”, “left”, and “right” are used, but these are used for convenience and do not limit the absolute positional relationship in the state in which the image formation apparatus is arranged.

In one or more embodiments described above, the case has been described in which the image formation apparatus is the color printer. However, the disclosure may be applied to any other image formation apparatuses such as a mono-color printer, a copier, a fax machine, a multifunctional peripheral (MFP) that combine these devices, and the like.

The invention includes other embodiments or modifications in addition to one or more embodiments and modifications described above without departing from the spirit of the invention. The one or more embodiments and modifications described above are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An image formation apparatus comprising:
a plurality of development devices that are provided in a main body of the apparatus and each include a drive gear portion; and
a plurality of transmission gear members provided corresponding to the plurality of development devices, wherein
each of the plurality of transmission gear members include an output gear portion that is engaged with the drive gear portion of the corresponding development device and configured to output drive force of a drive source,
the plurality of development devices includes a first development device and a second development device that are adjacent to each other, and
when a virtual line connecting a rotation center of a first output gear portion, which is the output gear portion corresponding to the first development device, and a rotation center of the corresponding drive gear portion is referred to as a first virtual line and a virtual line connecting a rotation center of a second output gear portion, which is the output gear portion corresponding to the second development device, and a rotation center of the corresponding drive gear portion is referred to as a second virtual line, a smallest angle θ1 of rotation angles of gear teeth on the first output gear portion in a rotation direction with respect to the first virtual line is different from a smallest angle θ2 of rotation angles of gear teeth on the second output gear portion in a rotation direction with respect to the second virtual line.

2. The image formation apparatus according claim 1, wherein
each of the plurality of transmission gear members include an input gear portion that is engaged with a gear member on a side of the drive source in a gear row from the drive source to the output gear portion,
the input gear portion is formed in a region different, in a direction of a rotational axis of the transmission gear member, from that of the output gear portion, and
the number of gear teeth on the input gear portion is greater than the number of gear teeth on the output gear portion.

3. The image formation apparatus according claim 2, wherein
each of the output gear portions has the gear teeth at a constant rotation angle θ,
the rotation angle θ1 and the rotation angle θ2 satisfy ¼≤|θ1−θ2|/θ≤¾, and
the number of the gear teeth on the input gear portion is twice or more compare to the number of the gear teeth on the output gear portion.

4. The image formation apparatus according to claim 3, wherein
the plurality of development devices includes:
the second development device that is arranged adjacent, in a first direction side, to the first development device, the second development device and the first development device being aligned in the first direction;
a third development device that is arranged adjacent, in the first direction side, to the second development device;
a fourth development device that is arranged adjacent, in the first direction side, to the third development device, and
when the output gear portion corresponding to the third development device is referred to as a third output gear portion, the output gear portion corresponding to the fourth development device is referred to as a fourth output gear portion, a virtual line that connects a rotation center of the third output gear portion and a rotation center of the corresponding drive gear portion is referred to as a third virtual line, a virtual line that connects a rotation center of the fourth output gear portion and a rotation center of the corresponding the drive gear portion is referred to as a fourth virtual line, a smallest angle of rotation angles of gear teeth on the third output gear portion in the rotation direction with respect to the third virtual line is referred to as θ3, and a smallest angle of rotation angles of gear teeth on the fourth output gear portion in the rotation direction with respect to the fourth virtual line is referred to as θ4, ¼≤|θ3−θ2|/0≤¾ and ¼≤|θ4−θ3|/0≤¾ are satisfied.

5. The image formation apparatus according to claim 4, wherein
the plurality of development devices includes a fifth development device that is arranged adjacent, in the first direction side, to the fourth development device, and
when a virtual line that connects a rotation center of a fifth output gear portion and a rotation center of the corresponding drive gear portion is referred to as a fifth virtual line, and a smallest angle of the rotation angles of gear teeth on the fifth output gear portion in the rotation angle with respect to the fifth virtual line is referred to as θ5, ¼≤ |θ5−θ4|/0≤¾ is satisfied.

6. The image formation apparatus according to claim 2, wherein
each of the output gear portions has the gear teeth at a constant rotation angle θ,
the rotation angles θ1 and θ2 satisfy ⅜≤|θ1−θ2|/θ≤⅝, and
the number of the gear teeth on the input gear portion is four times or more compared to the number of the gear teeth on the output gear portion.

7. The image formation apparatus according claim 1, wherein
each of the plurality of development devices includes an image carrier, and
the drive gear portion is formed at an end of the image carrier.

8. The image formation apparatus according claim 1, wherein
each of the plurality of development devices is detachably attached to the main body of the apparatus and the plurality of transmission gear members are provided to the main body of the apparatus.

9. A method for manufacturing an image formation apparatus, comprising:
preparing a plurality of transmission gear members each formed of a multi-stage gear including an output gear portion and an input gear portion having more gear teeth than the output gear portion;
attaching a first transmission gear member that is any one of the plurality of transmission gear members to a main body of an image formation apparatus;
attaching a second transmission gear member that is anyone of the plurality of transmission gear members to the main body of the image formation apparatus;
determining and maintaining, by using a jig, a gear teeth phase difference between a first output gear portion of the first transmission gear member and a second output gear portion of the second transmission gear member;
arranging gear rows between a drive source and the plurality of transmission gear members in which the phase difference is maintained; and
removing the jig.
